(19) United States
(12) Patent Application Publication
(10) Pub. No.: US 2013/0125026 A1
(43) Pub. Date: May 16, 2013

(54) SYSTEMS AND METHODS FOR ENABLING PERSONALITY FACETS HAVING VIRTUAL SOCIAL PROFILES

(71) Applicant: Nicolas Gaume, Paris (FR)

(72) Inventor: Nicolas Gaume, Paris (FR)

(73) Assignee: Mimesis Republic, Paris (FR)

(21) Appl. No.: 13/295,443

(22) Filed: Nov. 14, 2011

(51) Int. Cl. G06F 3/01; G06F 3/048

(52) U.S. Cl. 715/757; 715/753

(57) ABSTRACT

A computing system and methods that enable a Facet-based virtual layer to the social graph of an online service for network users. Virtual Personality Facets are provided so that users may role play, experiment with different personalities, or disguise their identity. Facets of personality may be represented by multiple virtual digital representations, such as avatars, of users in an online service having a social graph that allows a virtual representation. Facets may be designated as untraceable or traceable. A user may have multiple Facets, and may activate a Facet to be displayed to the other network users. Information about the user may be withheld if the Facet is designated to be untraceable.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of social graph systems, and in particular to enabling virtual personality Facets for digital representations in social online services.

### SUMMARY OF THE INVENTION

Users in an online service with a social graph may have the opportunity to experiment with different roles without the fear of consequences in Real-World. For example, users may not want their mothers to see them getting drunk or worse in a virtual world. By adding a Facet-based virtual layer to the social graph of an online service, and by giving users the control over the traceability of their Facets back to their real identity, users can feel confident to try out different roles or personality types. As such, young users are enabled to discover who they are, develop their personality, or simply have fun without it being necessary to reveal the person behind the mask/Facet. The disclosed system and method thereby allows users to compartmentalize their relationships.

In an embodiment, a computerized method is disclosed for providing virtual personality Facets for users in an online environment. A digital representation of a virtual personality Facet may be automatically generated. The virtual personality Facet is stored in a memory medium accessible to a computing device. The virtual personality Facet has a virtual profile for the user in a network service, which provides a social graph for all of the users in the network service. A digital representation is generated based on attributes associated with the profile of the virtual personality Facet, the digital representation being a representation of the user in the network service. The digital representation, Facet profile, and Facet data displayed to all users when active in the network service. For traceable Facets, a link to the Real-World profile of the user may also be accessible. Whether a traceable or untraceable Facet, a subgroup of Facet-connected users may have access to additional data and functionality above the standard, publically-visible information per Facet.

The Facets in accordance with various embodiments of the invention thus enable a layer social graphs between “virtual identities”, i.e., a Facet with an avatar and per Facet data, and such Facets may be traceable back to the real identity of the user or not. If the Facet is traceable, there is also the possibility of automatic and tailored aggregation of a subset of Facet data onto the real world profile. Given that the users connect based on Facets which represent virtual identities (not real profiles), they can utilize the connection process in interesting ways that they might be hesitant to utilize with their real profile, and accept or reject connections based on whether they want a specific virtual identity to be publicly related to another one. This choice gives users a way of explicitly managing the public image and public interpretations on their Facets by grooming their public associations with other Facets on a Facet-by-Facet basis. In this regard, the users' Facet connections contribute to their virtual personae since accepted facet connections are public, which adds a social and entertaining dimension to the connection process.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 illustrates a virtual personality Facet in a virtual environment as generated by a computer, in accordance with certain embodiments of the invention.

FIG. 2 shows a diagram of multiple virtual personality Facets, in accordance with certain embodiments of the invention.

FIG. 3 shows a flow chart of the generation of virtual personality Facets, in accordance with certain embodiments of the invention.

FIG. 4 shows a flow chart for the activation of a virtual personality Facet, in accordance with certain embodiments of the invention.

FIG. 5 shows a flow chart for a user's virtual personality Facet experimentation cycle, in accordance with certain embodiments of the invention.

FIG. 6 shows a flow chart for aggregating data for the Real World profile for virtual world Facet-based actions, in accordance with certain embodiments of the invention.

FIG. 7 shows a flow chart for the connection, disconnection, and reconnection cycle between Facets, in accordance with certain embodiments of the invention.

### DETAILED DESCRIPTION OF THE EMBODIMENTS

Reference will now be made in detail to the embodiments of the present invention, examples of which are illustrated in the accompanying drawings.

Social graphs describe the relationships between individuals online. The present invention pertains to a social graph system that is based upon virtual-life facets of personalities (herein, “Facets”) that are represented by multiple virtual digital representations, such as avatars, of users in an online service having a social graph that allows a virtual representation. The online service may be a social networking service, virtual world, dating site, instant messaging service, communications platform, massively multiplayer online role-playing game (MMORPG), etc.

In an embodiment, a method provides Facets of personality for users in a network service. The Facets may have one or more digital representations, including avatars, two-dimensional (2D) images, three-dimensional (3D) images, or realistic computer graphic representations. Such digital representations may be static or animated and may have power items, the power item being a virtual object that is associated with one or more predetermined virtual actions. Such power items are disclosed in detail in co-pending U.S. patent application Ser. No. 12/938,033, entitled “SYSTEMS AND METHODS FOR ENABLING VIRTUAL SOCIAL INTERACTIONS”, filed on Nov. 2, 2010, the entire disclosure of which is hereby incorporated by reference.

Such a digital representation may be rendered in a user interface of a network service including, but not limited to, a virtual world (such as Second Life, available from Linden Lab of San Francisco, Calif.), a social network service (such as Facebook, available from Facebook, Inc. of Palo Alto, Calif. and Google+ available from Google Inc. of Mountain View, Calif.), an online game (such as World of Warcraft, available from Blizzard Entertainment of Irvine, Calif.), game consoles (such as Xbox from Microsoft Corporation of Redmond, Wash. or Playstation from Sony Corporation of America, New York, N.Y.), an Internet webpage, a text message service (such as SMS or MMS), an instant messaging (IM) service (such as MSN available from Microsoft Corporation of Redmond, Wash., or Google Talk, available from Google Inc. of Mountain View, Calif.), an online blog, an online posting service (such as Twitter, available from Twitter, Inc. of San Francisco, Calif.), a mobile phone application or service, a teleconferencing service (such as video Skype), or a Web 2.0 application. The network service may include various paradigms, including web paradigms, 3D game paradigms, mobile service paradigms, and augmented reality paradigms.

Facets may have virtual Facet profiles that are generated based on votes cast for Comment Opportunities associated with digital representations. Such Comment Opportunities are disclosed in detail in co-pending U.S. patent application Ser. No. 12/974,059, entitled “Systems And Methods For Enabling Virtual Social Profiles”, filed on Dec. 21, 2010, the entire disclosure of which is hereby incorporated by reference. Comment/voting opportunities are provided so that users may vote or comment on profile contributions for a digital representation in a social online service. Such opportunities may also be managed by users. A Fameline may show all of the recently active Coms Opportunities for one Facet (or aggregated on the Real-World profile for all traceable Facets) on a timeline and may give other users an opportunity to vote on the active Coms Opportunities. Embodiments may include a Real-World profile display and usage. These embodiments may be implemented in 3D Virtual Worlds, Famelines, Facebook Applications, Facebook Walls, room selectors, promotional channels, Blogs, mobile phones, teleconferencing services, and instant messaging services.

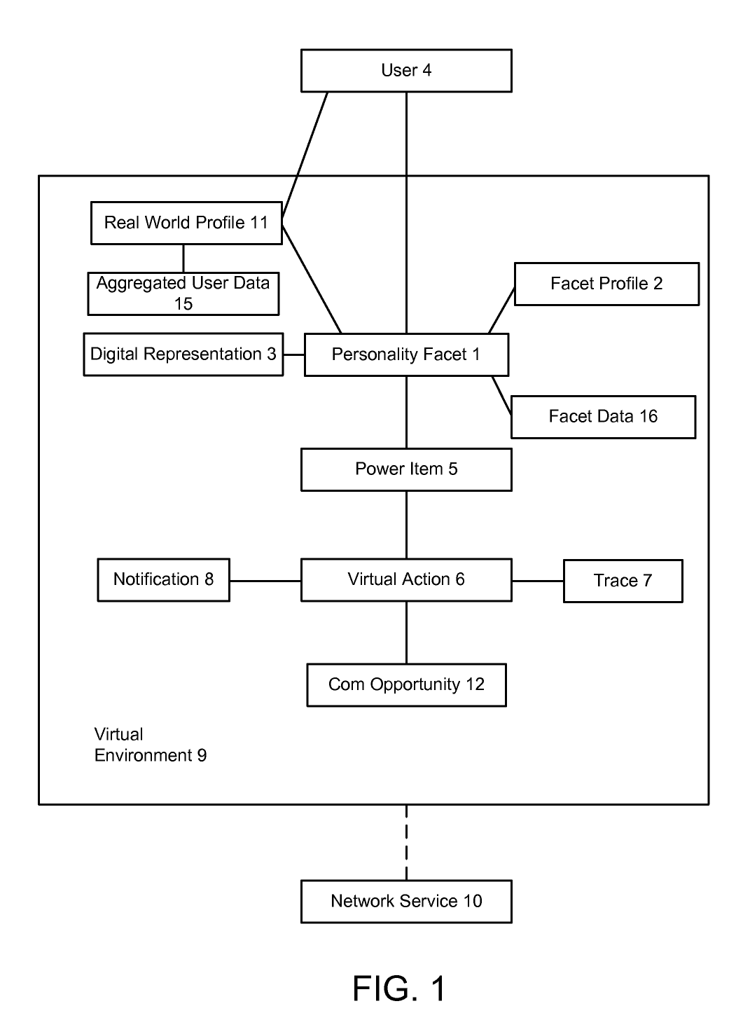

FIG. 1 illustrates a virtual Personality Facet 1 generated by a program on a computer. A Personality Facet 1 may have a virtual Facet profile 2 and Facet data 16. The Facet may include a digital visual representation 3 for a user 4. In addition, the Facet 1 may have a power item 5 associated with one or more predetermined virtual actions 6. One or more traces 7 and notifications 8 may be provided for the power item 5 based upon virtual actions 6 in the virtual environment 9 connected to a network service 10. In the case of a traceable Facet, a Facet's visual representations 3, traces 7, and notifications 8 may be used to traverse to and be aggregated on the user's Real-World profile 11. A virtual action 6 may be considered to be the virtual event that triggers the generation of a Com Opportunity 12 activated on a Facet 1. The virtual action 6 may be based on a digital recordation or representation of an event in the real world.

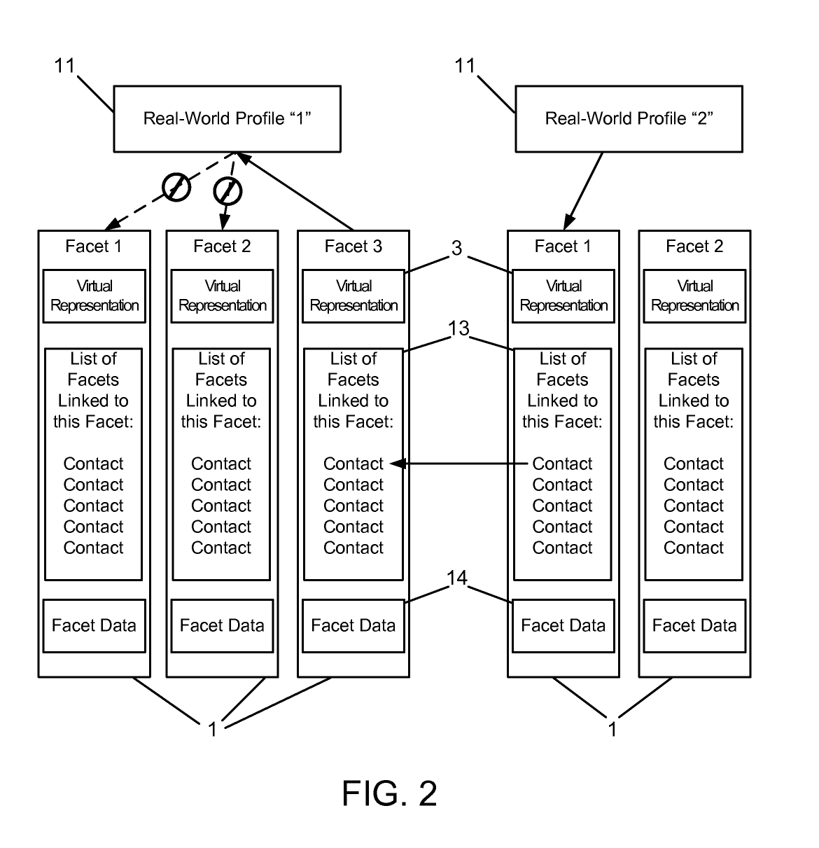

As illustrated by FIG. 2, Facets 1, whether designated as untraceable or traceable, may include virtual representations 3 plus unique information including Facet contact lists 13 and other data 14 such as Facet profiles, Fame points, votes, Action points, events history, feeds, etc. Users may create multiple Facets 1 to connect and interact through multiple Facets of their personality with a specific group of contacts 13 who are also linked (possibly multiple times) through their own Facets 1. In an embodiment, Facets may be untraceable by default so users can interact with anonymity; however, users can choose to make their Facets traceable if desired. In an alternative embodiment, Facets may be traceable by default. A traceable Facet is publicly linked and visible from the user's virtual Real-World profile in an online service.

User can dynamically develop their social graph. In an embodiment, a traceable Facet may not be changed to be untraceable but an untraceable Facet can be made traceable. In other words, once a Facet is made traceable, it is preferably always traceable because it becomes publicly known. An untraceable Facet, on the other hand, can be made traceable when the user chooses to. In an embodiment, the first Facet is traceable by default and then the second or later Facets for the same user are untraceable by default.

In an embodiment, the virtual representations 3 of a Facet may include: standard features that are selected one time only; and, multiple representations of dynamic features and data. The standard features may include the head shape, gender, and skin color of the digital representation of the Facet, such as an avatar. These features will be consistent over time so the facet can be uniquely identified. As such, they may are set only once so that the digital representation as a whole can be identified and distinguished from avatar of other users. Nonetheless, there may be multiple representations for the same Facet. A representation may vary as follows: 2D and 3D representations; representations of the Facet in different states; or, representations of the Facet's social profile. Although a Facet may be automatically generated, the Facet must be configured by the user. Accordingly, the user selects the dynamic features such as the Facet name, avatar, and profile information.

A user may select and activate a Facet. The active Facet information contains a Facet profile and Facet data that is accessible to all users. In an embodiment, when users interact in the 3D synchronous experience, all users interact with each other's active Facets, regardless whether they are untraceable or traceable. The active Facet: collects Com points; has Com Opportunities activated on it; and, is displayed in the GUI. In an embodiment, each Facet may have a social profile which may be based on Coms.

Facet data may change with usage. In an embodiment, Facet data may change synchronously on the active Facet when a user is in the 3D experience. For example, User U activates one of his Facets named Facet A, and looks at his Facet status page and realizes that his avatar is in a “clown” state. The state can be determined from the text describing his current state (“clown”) and from the current appearance of his avatar: red nose, clownish hairdo, and white makeup. When User U deletes this clown state, the avatar returns to being in its usual appearance: short haircut with a clean face. Later, User U may enter a room and interact with his friends' avatars. User U's friends may vote on whether to increase User U's “dark” Com. These additional votes may make User U's score of the “dark” Com become larger than the score of his “cool” Com. User U's Facet then becomes identified as being mainly dark instead of cool, and the Facet's corresponding social profile may be updated to reflect this change.

A Facet can be represented in different ways depending on its current context, and the corresponding relevant data. There may be one or many associated representations available simultaneously to represent the Facet. For example, such variations in the representations of a Facet may occur: when a user chooses a Facet to become active in a 3D representation for synchronous interactions; when the Facet information is viewed asynchronously; or, when Facet information is embedded in websites.

Examples of static representations include: text indicating the Facet name in text-related media, such as Twitter; html-type links built with unique paths to a Facet's information, like their profile page, 3D roometc; and, a unique graphic encoding standard that is supported in real-life (e.g. physical stickers, graphical prints on fabrics, prints in magazines, etc.) using barcodes or QR-codes which can be scanned to uniquely identify a Facet.

Dynamic representations change to respond to the user actions or the others interactions. Examples of dynamic representations include: a graphical composition of the graphic representations of the individual Coms that build the Facet's social profile, such as a set of three icons (one for each Com); a mug-shot of the face of the Facet's avatar, in a image/bitmap format, to be displayed on asynchronous web media, such as a web forum. These images may dynamically update as the Facet changes state, clothing, etc.

Dynamic and Static Combined examples include a 3D real-time animated avatar in 3D environment such as a virtual world and video game. While the face type and gender remain invariant, all the rest including haircut, makeup, and accessories are subject to instant and repeated changes.

Different Facet information may be available to different users based a user's Facet-connectivity status. For example, a Facet connected through a Facet Contact List may have access to more information than an unconnected Facet.

Accordingly, the availability/display of the link to the user's Real-World profile, and its list of traceable Facets is not available for untraceable Facets.

A Facet of one user can be connected to one or more Facets of other users. In an embodiment, the multiple Facets that are connected to the one user's Facet may be owned by the same user.

Real-World Profiles may make a user's personal information (name, contacts, etc) publicly viewable to their linked, Real-World contacts. Real-World Profiles may also allow a subset of information in aggregated user data 15 to be widely available to non-directly linked contacts. A Real-World Profile may aggregate a subset of their Facet information anonymously. For example, Fame points may be added together from all Facets but the source Facet for each contribution is not provided. Alternatively, a Real-World Profile may aggregate a subset of their Facet information with explicit, public references to each Facet that the user has made traceable. A Real-World Profile may have two layers in the social graph: a public, Real-World layer (similar to Facebook); and, an optionally untraceable virtual layer.

Each Facet can be linked to other Facets using virtual-type of contacts, such as Facet Contacts and Facet Contact Lists, as shown in FIG. 2. These virtual contacts can be associated to a single Facet. Hence, each Facet may have its own Facet Contact List.

The Real-World Profiles will have their own Real-World contacts, such as Contacts and Contact List. For example, Facebook has Real-World contacts that entitled ‘friends’ and each user has a corresponding list of friends. To keep the terminology neutral in this document, the present application will refer to such ‘friends’ as Contacts and these Contacts that are linked to the Real-World Profile will be referred to as being collected in Contact Lists instead of friends lists.

Users may have one Real-World Profile and multiple Facets. Some Facets are untraceable (no visible link back to the Real-World Profile) and some are traceable (the Facets are linked to the Real-World Profile so the user behind the Facet can be determined). Consequently, users may or may not be linked anonymously through their Facets. There is no need for the Real-World Profiles to be linked to other Real-World profiles to take advantage of the anonymity of untraceable Facets, but the Real-World Profile linking is useful for aggregating a subset of Facet data to provide a global view of the user's virtual world profile and activities in the Real-World (as long as it doesn't break their desired anonymity).

In embodiment, while users may create only one traceable Real-World Profile, they may create multiple untraceable and/or traceable Facets linked to that Real-World profile. This allows them to mix and match their Real-World identify with multiple virtual, online identities. Each Facet may be: a digital projection of a Facet of the user's personality, an aspirational aspect of how a user would like to be perceived, or a mask for a user to hide behind or to anonymously play a role through.

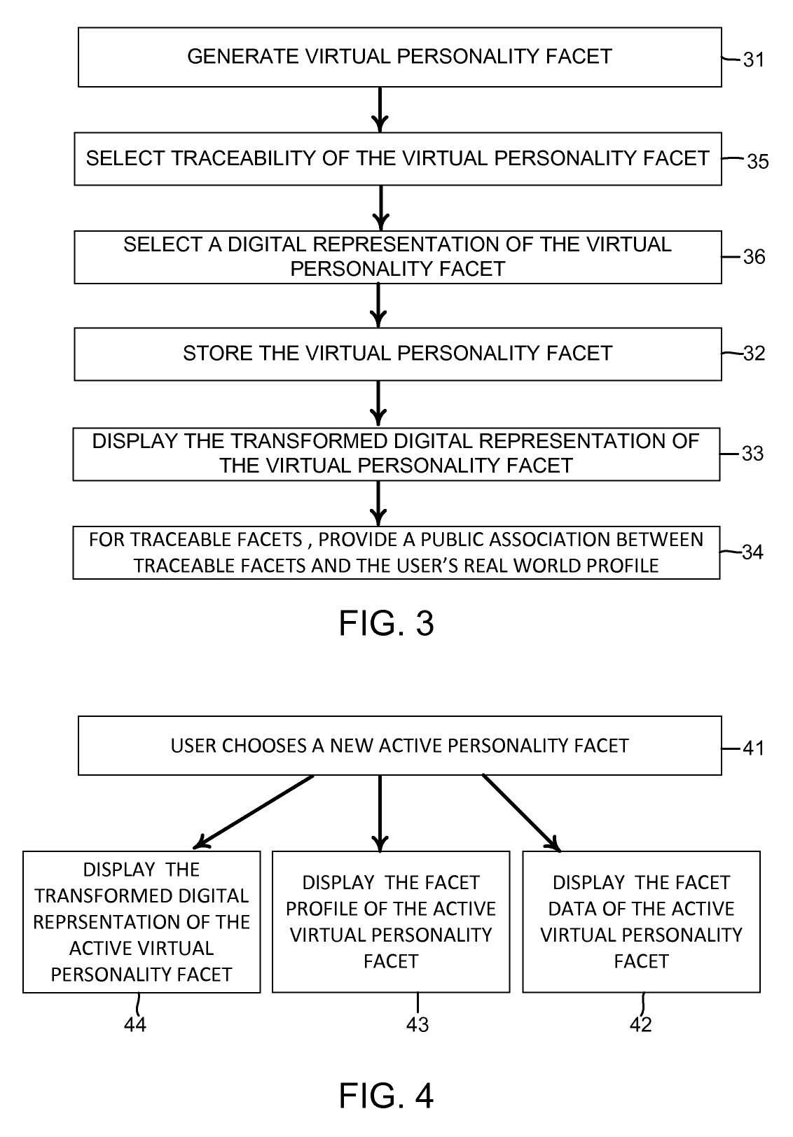

FIG. 3 illustrates an example of a method for providing virtual personality Facets having virtual social profiles in an online environment, in accordance with certain embodiments of the invention. A virtual personality Facet having a virtual profile and data may be generated 31 and stored 32 in a memory medium which is accessible to a computing device. The user may select 35 the traceability of the virtual personality facet. The user selects 36 a digital representation of the virtual personality facet. The digital representation of the virtual personality Facet may be displayed 33 to the users in the network service. The digital representation may be based on either the Facet's profile or data. If the Facet is traceable, the user's real world profile and aggregated user data may identify the real identity of the user. For traceable facets, a public association may be provided 34 between traceable facets and the user's real world profile. The above-referenced steps of generating, storing, displaying, and providing may be performed by a physical computing device.

The virtual personality Facet may be associated with a user in a network service that provides a social graph of users. In an embodiment, a newly created traceable Facet is automatically associated with a user when the user is connected to a network service. In addition, a digital representation of the user's aggregated data may be transformed, selected or replaced based on the virtual personality Facet. Further, the Facet attributes (such as Facet contact lists, Facet profiles, Com points, and associate data) may be transformed, selected or replaced.

As shown in FIG. 4, a user is able to select 41 one traceable or untraceable Facet at a time to be used in the synchronous virtual world. When the user activates a Facet, the digital representation is transformed and displayed 44, the profile for the active Facet is displayed 43 to other users in the service, and the data for that Facet is displayed 42 to other users in the service.

As explained above, a virtual personality Facet may be designated as traceable. In an embodiment, the traceable virtual personality Facet may be displayed via a digital representation to all users in the network service, and the user information may be available to all users. In an embodiment, a virtual personality Facet may sometimes be used in a anonymous manner and at other time used in a public manner, as designated by the user. In another embodiment, a Facet may not be designated as untraceable once it has been made public to all users.

When users interact together in the service with a social graph for virtual representation, users may be represented through their currently active Facet, as opposed to their Real-World Profiles. The currently active Facet may be untraceable or traceable. In the case of a traceable Facet, the Real-World Profile can be determined from the traceable Facet. Hence, the Real-World Profile is not obscured in an embodiment. For example, users can be represented by their Facets which may be primary recognized by: a unique Facet name; a digital representation, such as a 3D Avatar; a generated Facet profile, such as a profile based on Coms; an activity evaluation, such as points; or, a community recognition score, such a Fame. The types of service with a social graph allowing a virtual representation may include: social networking services, virtual worlds, instant messaging, asynchronous messaging service, or social games.

Users can be uniquely identified both by their Real-World Profile and any of their many Virtual-Life Facet Profiles independently. This means that the social graph is created in two layers: a public layer between the Real-World Profiles; and, a user-configured traceable-only, traceable-and-untraceable, or untraceable-only layer directly between the users' Facets. For the social graph, each unique Profile can have its independent Contacts List so a user will have at minimum two Contacts Lists, including: Real-World Profile Contact links to other Real-World Profiles; and, each Facet contact links to other Facets.

The Real-World Profile may have its own unique information and may aggregate a subset of the Facet information. If a user makes a Facet traceable, their Real-World Profile-connected users can obtain an addition view into the virtual lives of their connections through the traceable Facets. In an embodiment, Facets are untraceable by default so that users must opt-in to the traceable functionality since often having this traceable Facet behavior will often be undesired. Some examples where a traceable Facet could be desirable include: when a specific Facet becomes famous in the service and the user wants to associate their Virtual-Life fame with themselves in the Real-World; and, when a user wants to use one or more of their Facets in the service to connect with their Real-World contacts and to publicly share everything that they do together in the virtual world.

Examples of information on the Real-World Profile may include: real first and last names; geographic location; age or birth date; identity photograph; contacts list; resources owned; money in vibes; money in blings; or, assets inventory (room items, clothing & accessories, power items . . . ). If a Facet is traceable, the Real-World Profile may aggregate: Fame points; Facet profiles; or Feedback stream from the activities of the Facet (screenshots, movies and texts). If a Facet is untraceable, the Real-World Profile may anonymously aggregate a subset of the information available from a traceable Facet. Examples of information on each Facet may include: Facet name; Gender; Digital representations (Avatar); Facet Contacts list; Fame points; Social profiles (via Coms); Recent events feed; Stack of the recent states; Activity evaluations (points, how well you behave, according to what the system expects); Groups it belongs to; Name of the room it owns (and a link to it); or, Presence (connected to the service or not, and if connected location of an avatar in the virtual service).

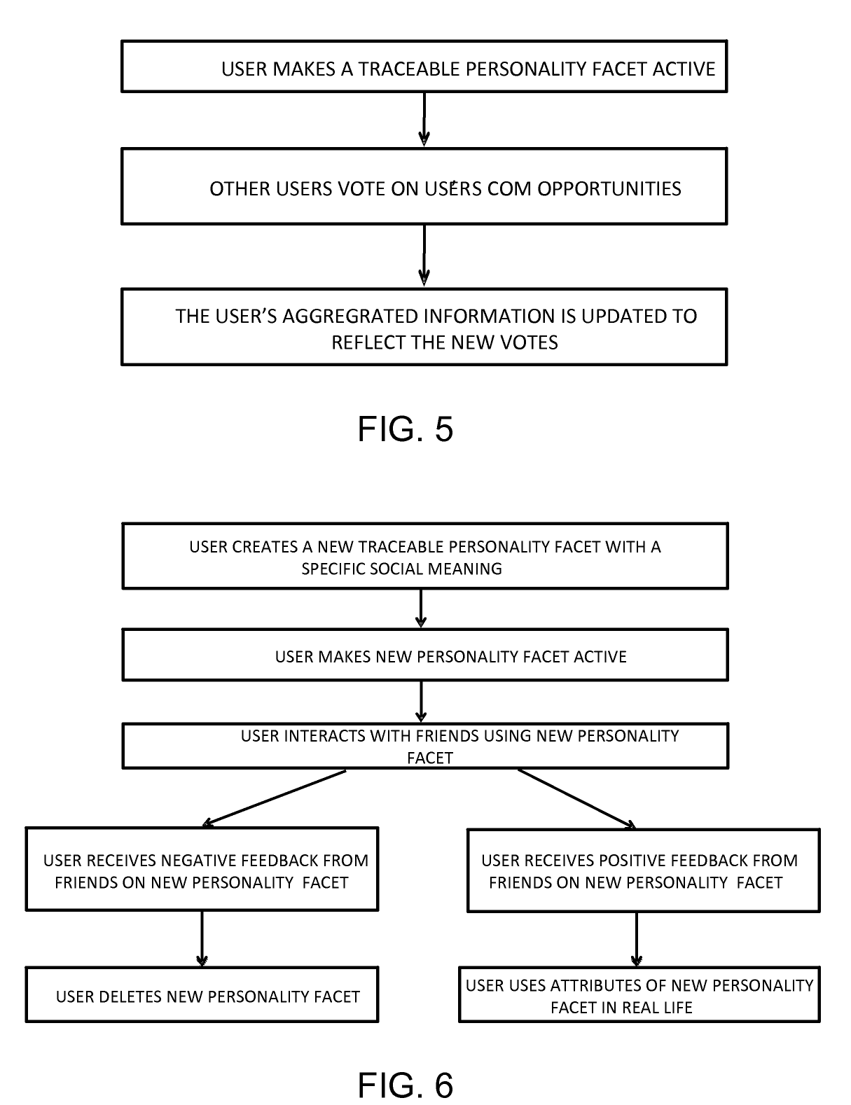

FIG. 5 presents a embodiment for data aggregated on the real world profile based on Com opportunity votes. A user is able to activate a traceable Facet, interact with other users, and receive votes on the generated Com opportunities. Because the Facet is traceable, the Com-based, social profile information on the real world profile may be updated to reflect the change in votes.

In order to provide identity continuity in interactions between Facets, some information can only be configured at the time that the Facet is created so the Facet can be uniquely identified even when, for example, the user changes their Facet's avatar's outfit. For example, the single-time settable information may include: Facet name (can be changed once in the lifetime of the Facet); Gender; Face and Head shape; and, Skin color.

The Real-World Profile may effectively own all of the Facets and may be used to manage them. The Real-World Profile can operate like a global unique identifier and global account for a user. For example, when purchases are made with virtual currency, the Real-World Profile digitally may store the wallet that all payments are taken from regardless of the currently active Facet. In an embodiment, when a Facet's avatar is given a hat to wear, it may become unavailable from the global inventory of clothing for all the user's Facet's other avatars. If the user wishes to put the hat on a different Facet's avatar, the hat must either be removed from the first Facet or a new hat must be obtained.

In an embodiment, a user is able to delete a Facet, but if so, they lose all of the Facet profile information and Facet data: associated history, points, Facet contacts, etc. When deleted, the items attached to the avatar that are linked to the Facet are returned into the user's sharable inventory.

The Real-World Profile may use an existing social networking service profile to create the public social graph between Real-World users. For example: in Facebook, Real-World users would connect to one another as usual, but once a user utilizes Facebook applications of the network service or links their Facebook account to the network service, their contacts would be available to the Facebook applications and the network service meaning the service could start sharing information about their virtual interactions through the network service with their Facebook contacts.

An existing social networking service may be extended or enhanced by embedding the Real-World Profiles and Facets. For example: an untraceable virtual identity layer may be added to Facebook by integrating with Facebook Connect and by implementing Facebook applications that post to the user's feed (when the Facet is untraceable, identifying information like names of avatars would be withheld, keeping the user's Facet anonymous).

The disclosed system has the advantage of providing anonymity to users when they interact. Traditionally, social networks only allow for one Real-World profile and once users are linked, all of the users have access to the same information on their contacts. For example, one person might go to a party with some friends, a compromising photo is taken, the photo is uploaded with you tagged in it. Now the person's mother, work colleagues, and potential employers know that they are a bit more wild and crazy than they want to let on. In a traditional social networking service, the way a user can try to provide this anonymity is to create additional, semi-secret profiles and maintain different contact lists. This approach can quickly break down. For example, currently in Facebook, feeds of friends can reveal information about other users one level outside the friend's immediate contact links when for example, a directly connected user comments on a photo of a once-removed connected user. Even by creating additional profiles and maintaining separate contact lists, a lack of privacy can result when, for example, one of a user's charming and respectable friends (who is linked to the user's additional, semi-secret profile) accepts the user's mother's Facebook “friend” request and now the user's mother will see any “Likes” and tagged photos referring to the user's additional profile which break the desired level of privacy. Besides the difficulty of keeping information private in a traditional social networking service, it can be a challenge to can also be inconvenience and difficult to keep straight which profiles should be connected to which ones. This invention makes selected privacy and anonymity in the social graph a first class feature.

In an embodiment, a Facet may be used to compartmentalize relationships. For example, a User A, Mother B and a Friend C connect to Mamba Nation using Facebook Connect which implicitly links to the Real-World Profile for each of them. Additionally, User A creates one traceable Facet (Loving Daughter A) and one untraceable Facet (Rebel A) Mother B creates one traceable Facet (Loving Mother B) and Friend C creates one untraceable Facet (Partier C). User A requests to connect to Mother B's Facet, Loving Mother B, through her Loving Daughter A Facet and to connect to Friend C's Facet, Partier C, through her Rebel A Facet. Whenever User A wants to do something with Friend C that Mother B does not approve, she connects to Mamba Nation with her Rebel A Facet without having to worry about any of her adventures getting back to Mother B through her Loving Mother B Facet link and associated update mechanics. Untraceable Facets have provided a way to achieve the desired anonymity between User A and Mother B.

As shown in FIG. 6, users may use Facets to experiment with their real life identity. A user is able to create and activate a new Facet with a specific social meaning, interact with their friends, and collect feedback on the suitability or acceptance of the social meaning for themselves. Based on the feedback, the user may choose to delete the Facet or to further associate the Facet with their real-world identity.

Facets can enhance Real-World social graphs/contacts be used to dynamically experiment with identities. For example, User U wants to party with friends at the nightclub tonight in real-life. User U creates a new Facet entitled “ultra-raver” and dresses the avatar with flashy clothes and sets it in a techno dancing state. User U then enters a disco room in Mamba Nation and starts behaving as a raver. In the disco room, User U generates media that he then posts onto his Facebook wall. User U's party friends watch the media on Facebook and may post comments. If four out of five consider the raver attitude doesn't fit User U, User U's attempt at being a raver may be considered as a failure and User U may delete his “ultra-raver” Facet. Further, User U may decide that he won't attend the real world party as a raver and opt for a more conventional attire for the evening.

Facets may be used to test a new profile and see if a user is successful at it, according to an embodiment. For example, a user A wants to try what it would be like to be a heavy-metal fan. He creates a new Facet, names it and dresses his avatar up like a heavy metal fan would, adopts a heavy-metal way to talk, and hangs out in the heavy-metal-related rooms. He may collect new contacts and try to be recognized as a genuine heavy-metal enthusiast. He would never perform this new role as comfortably if he had to initiate it with the fear of the judgment of the people that he already knows (e.g. his mother). In the end, if he turns out to be well-accepted as a heavy metal fan by the community, he may fully assume this Facet and link it publicly to his Real-World identity.

In an embodiment, Facets may be used to check on the user's Real-World contacts. For example, Users A and B are already linked through their Facets A1 and B1. User A may want to create a new Facet A2 and check anonymously on Facet B1.

Facets may be used to access different groups, according to an embodiment. For example, groups can use social profiles as a key to let people in or to keep them out. A user can create a collection of traceable and untraceable Facets to become a member of different groups. This way, a user can build a Real-World reputation as he is able to be simultaneously members of different, prestigious, non-compatible groups. For example, she can simultaneously be a member of the “pole dance heavy tippers group” and of the “feminist league of virtue”.

In an embodiment, users may participate in a role play. For example, some role plays take more than a clothing change to get into a role. Social profiles can be a necessary part of the game and building a matching Facet will let the user access new abilities.

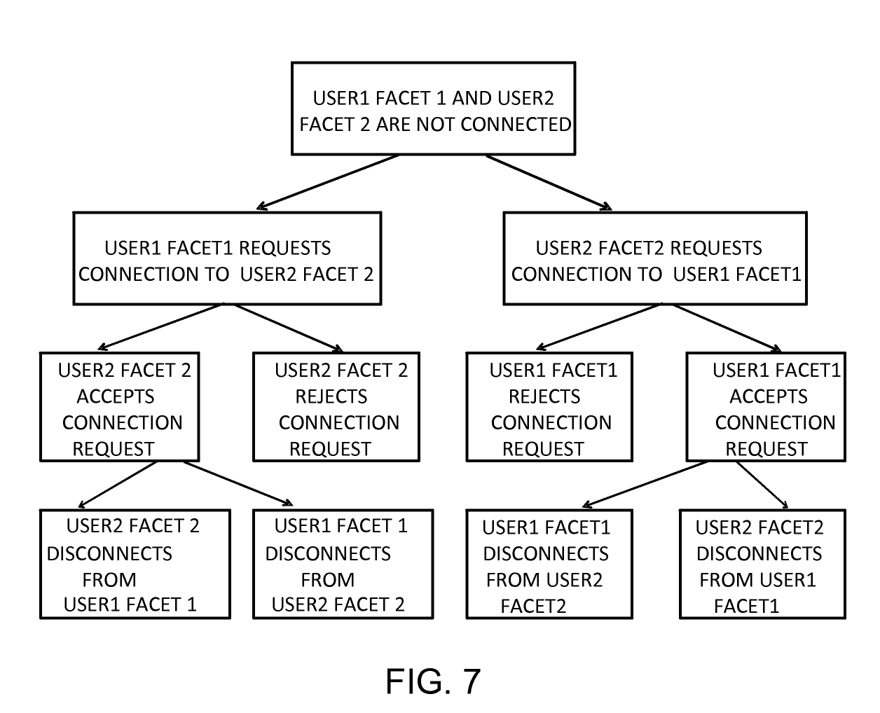

As shown in FIG. 7, users may connect, disconnect, and reconnect any of their Facets multiple times. Each time a connection is broken or established, it alters the social graph and corresponding systems, such as User Data aggregated on the Real World Profile, as defined in other embodiments.

In addition, history of connections, disconnections, and reconnections can be included in systems such as the Fameline as disclosed in detail in co-pending U.S. patent application Ser. No. 12/974,059, entitled “Systems And Methods For Enabling Virtual Social Profiles”, filed on Dec. 21, 2010, the entire disclosure of which is hereby incorporated by reference.

Because Facets can be socially interpreted by who they associate with by connecting, disconnecting, and reconnecting Facets users are given an opportunity to affect the social meanings and interpretations of the members of the community. For example, User A's Fun Facet and User B's Party Facet are connected, but at an event User B talks inappropriately with the girlfriend of User A while using his Party Facet. As a signal of outrage, User A disconnects his Fun Facet from User B's Party Facet. A few hours later, User A and User B talk it out and User B's Apology and Party Facets request connections with User A's Fun Facet. User A accepts signaling to the community that he accepts the apology and still wants to hang out with User B.

Embodiments of the disclosed system and method may involve various components of a computer system. The particular architecture or manner of interconnecting the components may vary. Certain systems may have fewer or more components. In an embodiment, a system may implement a central server and terminals/clients. Other configurations are possible, as will be readily apparent to those skilled in the art.

A system may include an inter-connect (e.g., bus and system core logic), which interconnects a microprocessor(s) and memory. The microprocessor may be coupled to cache memory. The inter-connect may interconnect the microprocessor(s) and the memory together and also interconnects them to a display controller and display device and to peripheral devices such as input/output (I/O) devices through an input/output controller(s). Typical I/O devices include mice, keyboards, modems, network interfaces, printers, scanners, video cameras and other devices which are well known in the art.

The inter-connect may include one or more buses connected to one another through various bridges, controllers and/or adapters. In an embodiment the I/O controller includes a USB (Universal Serial Bus) adapter for controlling USB peripherals, and/or an IEEE-1394 bus adapter for controlling IEEE-1394 peripherals.

The memory may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, the central servers may be implemented using one or more data processing systems. In some embodiments, one or more servers of the system may be replaced with the service of a peer to peer network or a cloud configuration of a plurality of data processing systems, or a network of distributed computing systems. The peer to peer network, or cloud based server system, can be collectively viewed as a server data processing system.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as computer programs. Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer readable storage medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

While the invention has been particularly shown and described with reference to a embodiment thereof, it will be understood by those skilled in the art that various changes in form and details may be made therein without departing from the spirit and scope of the invention.

What is claimed is:

1. A method for providing virtual personality facets having virtual profiles in an online environment, comprising the steps:
generating a virtual personality facet in association with a user in a network service, the virtual personality facet having a virtual profile, and wherein the network service provides a social graph of users and facets in the network service;
storing the virtual personality facet in a memory medium, wherein the memory medium is accessible to a computing device;
displaying a digital representation for the virtual personality facet, wherein the digital representation is based in part on the virtual profile for the virtual personality facet and in part on facet data for the user in the network service, wherein the digital representation is displayed to the users in the network service;
providing an optional, user-configured association to the user's real world profile and aggregated user data based on traceability status of the virtual personality facet, wherein the real world profile identifies the user; and,
wherein said steps of generating, storing, displaying, and providing are performed by at least one physical computing device.

2. A method for managing virtual personality facets having virtual profiles and associated data in an online environment, comprising the steps:
determining a traceability status of a virtual personality facet, the virtual personality facet having a virtual profile, wherein the virtual personality facet is publicly or anonymously associated with a user in a network service, and wherein the network service provides a social graph of users and facets in the network service;
displaying a digital representation of the virtual personality facet to the users in the network service, wherein the digital representation is based in part on the virtual profile for the virtual personality facet and in part on facet data for the user in the network service;
providing an optional, user-configured association to the user's real world profile and aggregated user data based on the traceability settings of the virtual personality facet, wherein the real world profile identifies the user; and,
wherein said steps of determining, displaying, and providing are performed by at least one physical device.

3. The method of claim 1 or 2, wherein the virtual personality facet is capable of being designated as either untraceable or traceable.

4. The method of claim 1 or 2, wherein the virtual personality facet is designated as traceable by default.

5. The method of claim 1 or 2, wherein the virtual personality facet is designated as untraceable by default.

6. The method of claim 1 or 2, wherein the virtual personality facet is designated as traceable and is incapable of being re-designated as untraceable.

7. The method of claim 1 or 2, wherein the traceability status of the virtual personality facet is selected by the user.

8. The method of claim 1 or 2, wherein the traceability status of the virtual personality facet is designated as traceable, and wherein the association to the user's real world profile is provided to all of the users of the network service.

9. The method of claim 1 or 2, wherein the privacy status of the virtual personality facet is designated as untraceable, and wherein the association to the user's real world profile is not provided to any users of the online service.

10. The method of claim 9, wherein the facet-connected users are selected by the user.

11. The method of claim 1 or 2, wherein a portion of the facet profile and data is accessible to all of the users of the network service.

12. The method of claim 1 or 2, wherein the portion of the user data is aggregated publicly for traceable facets.

13. The method of claim 1 or 2, wherein the portion of the user data is aggregated anonymously.

14. The method of claim 1 or 2, wherein the selection of users in the network services comprises users listed in a contacts list of the user.

15. The method of claim 1 or 2, wherein the virtual personality facet has a virtual facet contact list.

16. The method of claim 15, wherein the virtual facet contact list comprises contact information for a plurality of virtual personality facets.

17. The method of claim 15, wherein the virtual facet contact list comprises facet profile information listed in a facet contacts list of the user.

18. The method of claim 1 or 2, wherein the user has a plurality of virtual personality facets.

19. The method of claim 18, wherein the user is able to create and delete a plurality of virtual personality facets.

20. The method of claim 18, further comprising:
activating one virtual personality facet of the plurality of virtual personality facets; and,
displaying a digital representation for the activated virtual personality facet, wherein the digital representation is based in part on the virtual profile for the activated virtual personality facet and in part on facet data for the user in the network service, wherein the digital representation is displayed to the users in the network service.

21. The method of claim 1 or 2, wherein the facet data compromises event history.

22. The method of claim 1 or 2, wherein the facet data compromises points.

23. The method of claim 1 or 2, wherein the virtual personality facet is displayed as a text.

24. The method of claim 1 or 2, wherein the virtual personality facet is displayed as a two-dimensional (2D) image.

25. The method of claim 1 or 2, wherein the virtual personality facet is displayed as a three-dimensional (3D) image.

26. The method of claim 1 or 2, wherein the virtual personality facet is associated with a virtual action.

27. The method of claim 26, wherein the virtual action is selected from a group consisting of the following actions: a virtual social interaction between the virtual personality facet and other virtual personality facets of other users, virtual events based on contextual information of the virtual environment in the network service, virtual events triggered by other network services, or virtual events triggered by a generation of a digital record for a virtual event or a Real-World event.

28. The method of claim 27, wherein the contextual information is selected from a group consisting of the following: an user status; an user state; a virtual social interaction between a plurality of virtual personality facets in the network service; a virtual location or setting in the network service; or a virtual social context or relationship between a plurality of virtual personality facets in the network service.

29. The method of claim 1, wherein the computing device is a smart phone or a personal digital assistant (PDA).

30. The method of claim 1, wherein the computing device is a computer.

31. The method of claim 1 or 2, wherein the digital representation is a representation selected from a group consisting of the following: a two-dimensional (2D) image; a three-dimensional (3D) image; a realistic computer graphic representation; an avatar; a static representation; or an animated representation.

32. The method of claim 1 or 2, wherein the network service is a service selected from a group consisting of the following: a virtual world; a social network service; an online game; an Internet webpage; a text message service; an instant messaging service; an online blog; a teleconferencing service; or an online posting service.

33. The method of claim 1 or 2, wherein the virtual personality facet is connected to at least one facet, wherein the at least one facet is associated with another user.

34. The method of claim 1 or 2, wherein the virtual personality facet masks the user in the network service.
